(19) United States
(12) Patent Application Publication
(10) Pub. No.: US 2023/0106345 A1
(43) Pub. Date: Apr. 6, 2023

(54) PRINTING ELECTRONIC DOCUMENTS FROM LARGE HTML SCREENS

(71) Applicant: SAP SE, Walldorf (DE)

(72) Inventors: Ashish Anand, Bangalore (IN); Sanchit Shrivastava, Bangalore (IN); Bhuwan Rawat, Bangalore (IN); Suneet Agarwal, Lucknow/Uttar Pradesh (IN); Reshma R Varma, Thrissur (IN); Ashwin Kumar Bolar, Bangalore (IN)

(21) Appl. No.: 17/491,725

(22) Filed: Oct. 1, 2021

(51) Int. Cl. G06F 16/11; G06F 16/93; G06F 40/106; G06F 40/166

(52) U.S. Cl. CPC G06F 16/116; G06F 16/93; G06F 40/106; G06F 40/166

(57) ABSTRACT

To print electronic documents from large HTML screens, a user interface component rendered by a computer application on a display device is identified. The user interface component is divided into multiple sub-components. Each sub-component is converted into a respective canvas component resulting in multiple canvas components. A size of each sub-component is selected such that a time taken to convert each sub-component into the respective canvas component is less than a threshold timeout associated with the computer application that rendered the user interface component. The multiple canvas components are converted into a portable document format (PDF) document. The PDF document is displayed on the display device.

### TECHNICAL FIELD

The present disclosure relates to computer-implemented methods, software and systems for printing electronic documents, for example, documents in portable document format (PDF).

### BACKGROUND

HTML5 is a markup language used for structuring and presenting content on the World Wide Web. Computer applications developed using HTML5 are adaptable to and executable on a range of browsers and devices including, for example, smart phones, tablets, and desktops. In some instances, a user may want to export or print a user interface rendered by a computer application executing HTML5 into an electronic document, for example, a PDF document. To do so, the computer application, that displays the user interface, converts the user interface into the electronic document. If the user interface is resource intensive, for example, large in size, then the time that the computer application requires to convert the user interface into the electronic document can be greater than a threshold timeout for the computer application. In such instances, the computer application can fail to convert the user interface into the electronic document, and display an error message.

### SUMMARY

This specification describes technologies relating to printing electronic documents from large HTML screens.

Certain aspects of the subject matter described here can be implemented as a computer-implemented method. A user interface component rendered by a computer application on a display device is identified. The user interface component is divided into multiple sub-components. Each sub-component is converted into a respective canvas component resulting in multiple canvas components. A size of each sub-component is selected such that a time taken to convert each sub-component into the respective canvas component is less than a threshold timeout associated with the computer application that rendered the user interface component. The multiple canvas components are converted into a portable document format (PDF) document. The PDF document is displayed on the display device.

An aspect combinable with any other aspect includes the following features. To convert the multiple canvas components into the PDF document, the multiple canvas components are merged into a single merged canvas component. The single merged canvas component is converted into the PDF document.

An aspect combinable with any other aspect includes the following features. To convert the multiple canvas components into the PDF document, each canvas sub-component is converted into a respective PDF document portion resulting in multiple PDF documents, each of which is a portion of the PDF document. The multiple PDF documents are merged into the PDF document.

An aspect combinable with any other aspect includes the following features. A size of each canvas sub-component is selected based on a threshold size of a canvas sub-component that the computer application that rendered the user interface can support.

An aspect combinable with any other aspect includes the following features. Input including a number of the multiple sub-components into which the user interface is to be divided is received. To divide the user interface component into the multiple sub-components, the user interface component is divided into at least the number of the multiple sub-components specified in the input.

An aspect combinable with any other aspect includes the following features. To divide the user interface component into the multiple sub-components, the user interface component is divided into multiple horizontal or vertical sub-components.

An aspect combinable with any other aspect includes the following features. User input is received to convert the user interface component into the PDF document.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is an example of a flow diagram of a method of printing electronic documents from large HTML screens.

FIG. 2 is a flow chart of an example of a process of printing electronic documents from large HTML screens.

FIG. 3 is an example of a flow diagram of another method of printing electronic documents from large HTML screens.

FIG. 4 is a flow chart of an example of a process of printing electronic documents from large HTML screens.

FIG. 5 is an example of a display device displaying a user interface generated using HTML5.

FIG. 6 is an example of the display device displaying a user interface showing progress of converting the user interface of FIG. 5 into an electronic document.

FIG. 7 is an example of the display device displaying a preview of the electronic document.

FIG. 8 is an example of the display device displaying the electronic document.

Like reference numbers and designations in the various drawings indicate like elements.

### DETAILED DESCRIPTION

When a computer application, for example, a web browser, executes a computer program, for example, loads a webpage on a display device of a computer system, the computer application parses all of the HTML resources that form the webpage before displaying the webpage on the display device. Sometimes, the HTML resources include links to other files, for example, a CSS file, a JavaScript file or an in-line script (i.e., JavaScript code in the HTML itself). When the computer application encounters such a link, the computer application pauses the HTML execution to perform a non-JavaScript operation, for example, to fetch and execute the code. Doing so slows down the process of loading the webpage. Such execution of the HTML resources, whereby execution of additional JavaScript must wait until a non-JavaScript operation is completed, is called a blocking execution. If the time taken to execute the non-JavaScript operation exceeds a threshold timeout associated with the computer application, for example, a web browser timeout, then the computer application fails and, sometimes, displays an error message.

This disclosure relates to operations implemented by a computer application executed by a computer system to convert large HTML screens into electronic documents, for example, PDF documents. In a client-server environment, PDF printing (or PDF export) functionality of very large HTML screens at the client side is not considered scalable and is usually avoided. While providing such functionality at the backend layer may be an option, doing so introduces additional back end components and is not always logistically feasible for isomorphic client-side user interfaces. An isomorphic application is one whose code, for example, JavaScript, can run both in the server and the client. In particular, developing back end components for all known backend environments is a challenge, in particular, if the user interface (UI) element has complex graphical elements like scalable Vector graphics (SVG). Consequently, providing the PDF printing functionality at the client side becomes unavoidable.

However, providing the PDF printing functionality at the client side can also be challenging due to the following constraints. First, the UI component needs to be printed with complete data without any lazy loading of data or UI component. Lazy loading is the practice of delaying load or initialization of resources or objects until they are actually needed to improve performance and save system resources. Second, UI component rendering and other underlying steps like HTML to canvas conversion, and then canvas to PDF conversion are synchronous operations that can block the main thread of JavaScript execution on the client side, as JavaScript is single threaded. By single threaded, it is meant that JavaScript has one call stack and one memory heap. It executes code in order and must finish executing a piece of coding before moving on to the next. Thus if a function takes a while to execute or has to wait on something, such wait freezes all of the operations of the JavaScript execution. Third, certain computer applications, for example, web browsers, have limitations on the maximum HTML canvas object size. Thus, even if the UI component can be printed to PDF in a single step without exceeding the threshold timeout of the web browser, the web browser may not be able to support the size of the HTML canvas object to which the UI component is converted.

This disclosure describes a non-blocking algorithm for electronic document printing, for example, PDF printing, of very large HTML screens that overcome the issues described above. Briefly, a computer system identifies a user interface component rendered by a computer application on a display device. The computer system divides the user interface component into multiple sub-components. In the context of this disclosure, component refers to the whole, main HTML canvas, and sub-components refer to the blocks to which the whole, main HTML canvas is split. The computer system converts each sub-component into a respective canvas component resulting in multiple canvas components. A size of each sub-component is selected such that the time taken to convert each sub-component into the respective canvas component is less than a threshold timeout associated with the computer application that rendered the user interface. The computer system converts the multiple canvas components into a PDF document. The computer system displays the PDF document on the display device.

By implementing the techniques described in this disclosure, the issue of the web browser getting timed out because the main JavaScript thread waits on one main task which exceeds the defined threshold for the web browser can be avoided. The techniques described in this disclosure can also be implemented to overcome the issue of the canvas size exceeding browsers supported limits.

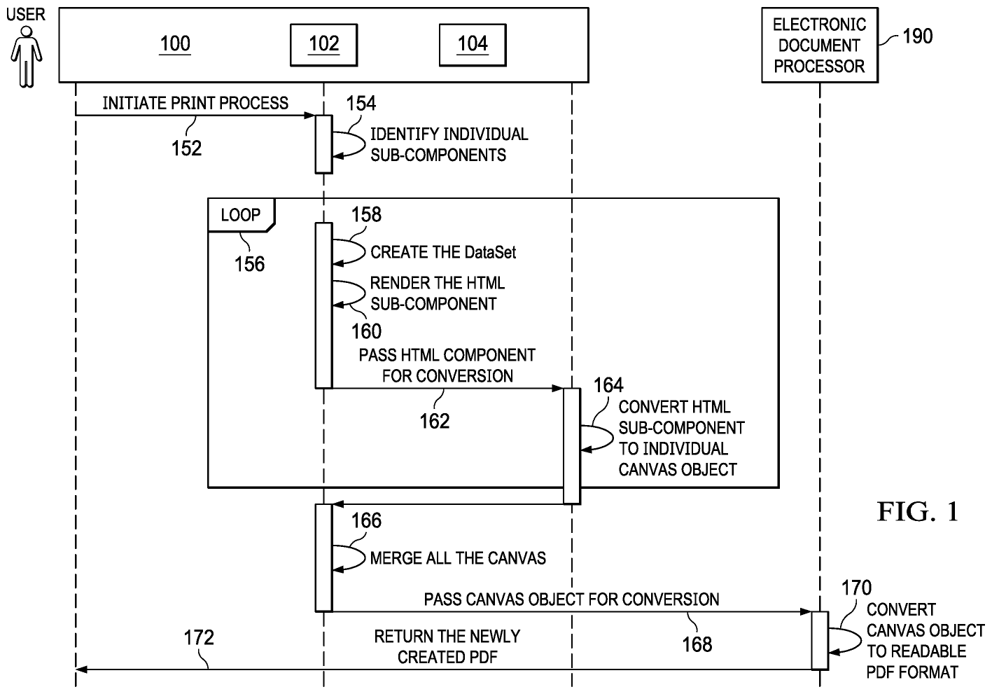

FIG. 1 is an example of a flow diagram of a method of printing electronic documents from large HTML screens. In some implementations, the flow diagram can be implemented by a computer system 100 that includes one or more processors 102, and a computer readable medium 104 operatively connected to the one or more processors 102 and the storing computer instructions executable by the one or more processors 102 to implement the flow diagram and other processes. In some implementations, the computer system 100 is a client-side computer system operatively connected to a backend server (not shown). All operations associated with the flow diagram are implemented on the client side by the computer system 100 without needing any assistance or resources from the backend server to implement the flow diagram.

To initiate the print process, a user provides an input to the computer system 100. For example, the user can select an object included in a user interface displayed in a display device. The selection of the object instructs the computer system 102 to initiate the print process. Alternatively or in addition, the computer system 100 can initiate the print process as part of a larger process and without a specific input, for example, from the user. In any of these manners, at 152, the computer system 100 initiates the print process.

At 154, the computer system 100 identifies individual sub-components that collectively form the user interface component rendered by the computer application on the display device. For example, the computer system 100 identifies the HTML screen rendered by the web browser on the display device. In the context of this application, a component or a user interface component encompasses typographies, forms, buttons, navigation and other resources that are executed by the computer application, for example, the web browser, to render the user interface component, i.e., the HTML screen, on the display device. In some implementations, each component is defined in a component.JS file in the same folder as the default file, for example, index.html, that is executed when a webpage is loaded in a web browser.

At 156, the computer system 100 executes a loop, which includes the following steps. At 158, the computer system 100 creates a data set needed to render an individual sub-component. In particular, the computer system 100 does not fetch all the data needed to render the entire user interface component, but rather fetches only the data needed to render the identified sub-component. For example, if the HTML canvas to be printed is a table with a header, columns, multiple rows and a footer, then the entire table is the component. The table can be divided into, for example, ten sub-components, each including ten rows, one sub-component including the header and another including the footer. In this example, to render one sub-component, the computer system 100 can fetch only the data needed to render that sub-component rather and not fetch all the data needed to render the entire table. The data can be available on the client side or, in some implementations, can be fetched from the backend to which the client is operatively coupled.

The identified sub-component is smaller in size and includes fewer resources compared to the user interface component as a whole. To identify the sub-component, the computer system 100 divides the user interface component into multiple parts. The size of each part is selected such that the time taken to convert the resources (i.e., contents) of each part into a respective canvas component (described below) is less than a threshold timeout associated with the computer application that rendered the user interface component. In addition, the size of each part is selected such that the time taken to convert each part into the respective canvas component is less than a time taken to convert the whole user interface component into a single canvas component. By doing so, the computer system 100 is able to convert each identified sub-component into a respective canvas component before exceeding the threshold timeout associated with the computer application, for example, the web browser. Consequently, the synchronous JavaScript execution to print the HTML screen into the electronic document does not fail.

At 160, the computer system 100 renders the HTML sub-component. Rendering the HTML sub-component means creating the HTML markup elements corresponding to the sub-component. At 164, the computer system 100 converts the HTML sub-component into a respective canvas component. In some implementations, the computer system 100 executes a software module (i.e., a collection of software code) to create the data set (step 158) and render the sub-component (step 160) and another, separate software module to convert the HTML sub-component into a canvas component. For example, the other, separate software module is an HTML canvas element used to draw graphics on the fly via scripting, usually JavaScript. In such implementations, the computer system 100 passes, at step 162, the HTML component rendered by executing the software module to the other, separate software module for conversion into the canvas component. The computer system 100 executes the loop 156 until all the sub-components that collectively form the user interface component to be converted into the electronic document have been identified and each converted into a respective canvas component.

At 166, the computer system 100 merges all of the canvas components into a single merged canvas component. In some implementations, the computer system 100 can execute the JavaScript code presented below to merge multiple canvas components into a single merged canvas component. The JavaScript code presented below is executable for sub-components generated by vertically slicing the user interface component. The JavaScript code can be modified and applied to sub-components generated by horizontally or otherwise slicing the user interface component.

```
/**
            * Merges multiple canvases into one canvas.
            *
            * @param {array} aCanvasArray array of vertically sliced canvases
            * @returns single merged canvas
            * @public
            */
            GanttPrinting.prototype.mergeCanvases = function (aCanvasArray) {
                  var newCanvas = document. createElement(′canvas′),
                        ctx = newCanvas.getContext(′2d′),
                        width = aCanvasArray[0].width,
                        temp = [ ],
                        height = aCanvasArray.reduce(function (sum, item, index,
a CanvasArray) {
                            temp.push({
                                  cnv: item,
                                  y: sum
                            });
                            sum += aCanvasArray [index], height;
                            return sum;
                        },0)
                  newCanvas. width = width;
                  newCanvas.height = height;
                  temp.forEach(function (n) {
                        ctx.beginPath( );
                        ctx.drawlmage(n.cnv, 0, n.y, width, n.cnv.height);
                  });
                  if (newCanvas.width > MAXCANVASSIZE ∥ newCanvas.height >
MAXCANVAS SIZE) {
                        return null;
                  }
                  return newCanvas;
};
```

The single merged canvas component is just one component that can then be converted into an electronic document, for example, a PDF document, in one step by an electronic document processor 190. The electronic document processor 190 can be a computer application separate from the computer application that rendered the user interface component but be executed by same the computer system 100. In some implementations, the electronic document processor 190 can be implemented as an add-on or plug-in functionality of the web browser.

At 168, the computer system 100 passes the single merged canvas component to the electronic document processor 190. At 170, the electronic document processor 190 converts the single merged canvas component into a single electronic document, for example, a PDF document. After conversion, the electronic document processor 190 returns the single electronic document to the computer system 100. Then, the computer system 100 displays the single electronic document in the display device.

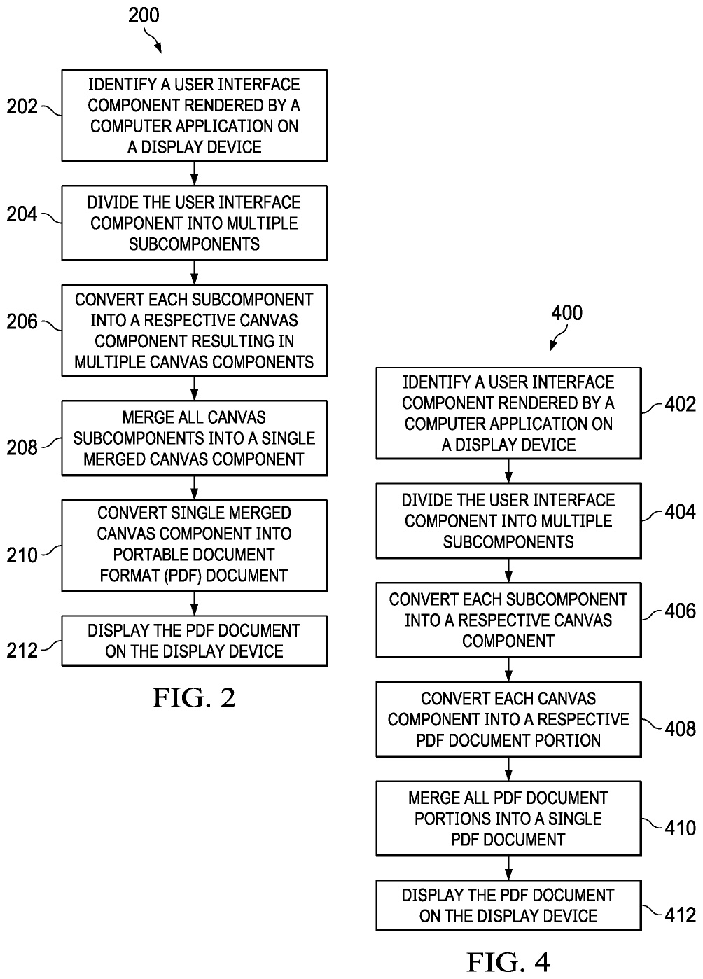

FIG. 2 is a flow chart of an example of a process 200 of printing electronic documents from large HTML, screens. In some implementations, the process 200 is executed by the computer system 100. At 202, the computer system 100 identifies a user interface component rendered by a computer application on a display device. At 204, the computer system 100 divides the user interface into multiple sub-components. At 206, the computer system 100 converts each sub-component into a respective canvas component resulting in multiple canvas components. At 208, the computer system 100 merges all canvas sub-components into a single merged canvas component. At 210, the computer system 100 converts the single merged canvas component into an electronic document, for example, a PDF document. For example, the computer system 100 passes the single merged canvas component to an electronic document processor 190, which converts the single merged canvas component into the PDF document. At 212, the computer system 100 displays the PDF document on the display device.

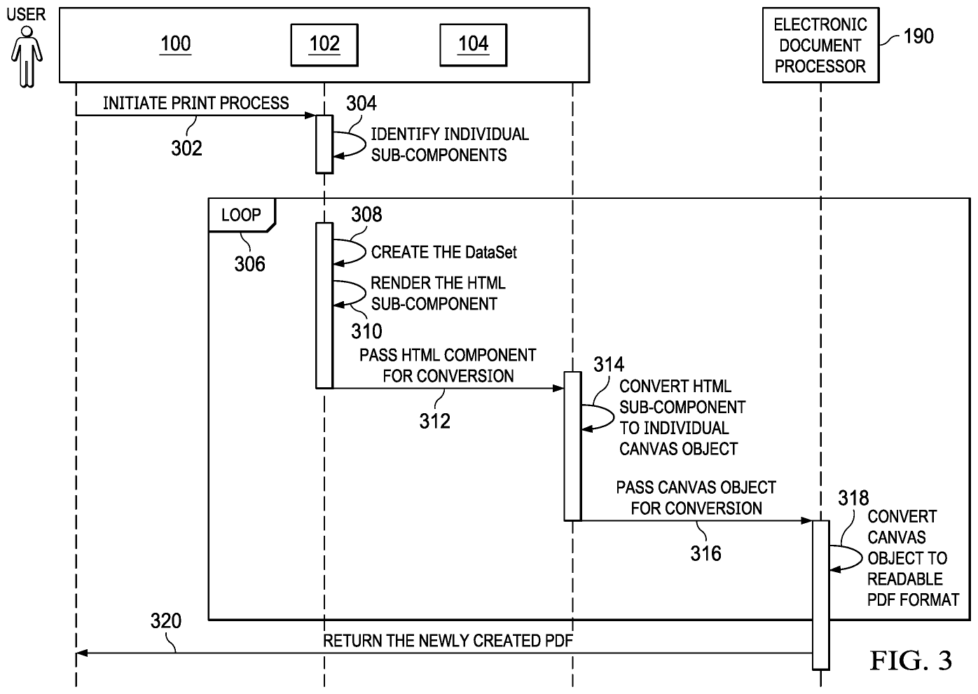

In the implementation described with reference to FIGS. 1 and 2, the computer system 100 merged multiple canvas components into a single canvas component. In some instances, the size of the single canvas component may exceed permissible limits, for example, maximum dimensions or area, associated with the computer application that rendered the user interface component, for example, the web browser. In such instances, the single canvas component is rendered unusable, and drawing commands will no longer work. The flow diagram and the flowchart described with reference to FIGS. 3 and 4, respectively, can be implemented to overcome this drawback.

FIG. 3 is an example of a flow diagram of another method of printing electronic documents from large HTML screens. Similar to step 152 in FIG. 1, to initiate the print process, a user provides an input to the computer system 100. For example, the user can select an object included in a user interface displayed in a display device, the selection of which instruct the computer system 102 initiate the print process. Alternatively or in addition, the computer system 100 can initiate the print process as part of a larger process and without a specific input, for example, from the user. In any of these manners, at 302, the computer system 100 initiates the print process.

Similar to step 154 in FIG. 1, at 304, the computer system 100 identifies individual sub-components that collectively form the user interface component rendered by the computer application on the display device. For example, the computer system 100 identifies the HTML screen rendered by the web browser on the display device.

At 306, the computer system 100 executes a loop, which includes the following steps. Similar to step 158 in FIG. 1, at 308, the computer system 100 creates a data set needed to render an individual sub-component. As described above, the computer system 100 does not fetch all the data needed to render the entire user interface component, but rather fetches only the data needed to render the identified sub-component.

As described above, the identified sub-component is smaller in size and includes fewer resources compared to the user interface component as a whole. To identify the sub-component, the computer system 100 divides the user interface component into multiple parts. The size of each part is selected such that the time taken to convert the resources (i.e., contents) of each part into a respective canvas component is less than a threshold timeout associated with the computer application that rendered the user interface component. In addition, the size of each part is selected such that the time taken to convert each part into the respective canvas component is less than a time taken to convert the whole user interface component into a single canvas component. Moreover, the size of each part is selected such that the size of the respective canvas component is less than permissible limits associated with the computer application that rendered the user interface component. By doing so, the computer system 100 is able to convert each identified sub-component into a respective canvas component before exceeding the threshold timeout associated with the computer application, for example, the web browser, and also while ensuring that the resulting canvas component is usable for post-processing, i.e., electronic document conversion.

Similar to step 160 in FIG. 1, at 310, the computer system 100 renders the HTML sub-component. Similar to step 164 in FIG. 1, at 314, the computer system 100 converts the HTML sub-component into a respective canvas component. As described above, the computer system 100 executes a software module (i.e., a collection of software code) to create the data set (step 308) and render the sub-component (step 310) and another, separate software module to convert the HTML sub-component into a canvas component. For example, the other, separate software module is an HTML canvas element used to draw graphics on the fly via scripting, usually JavaScript. In such implementations, the computer system 100 passes, at step 312, the HTML component rendered by executing the software module to the other, separate software module for conversion into the canvas component. In this implementation described with reference to FIGS. 3 and 4, the canvas component into which the HTML component is converted satisfies the permissible limits, for example, maximum dimensions or area, associated with the computer application that renders the user interface component. Consequently, the canvas component remains usable.

At this juncture, as described with reference to FIGS. 1 and 2, the computer system 100 repeated the steps to convert all HTML sub-components into respective canvas components and merged all the canvas components into a single merged canvas component. Instead, in the implementation described with reference to FIGS. 3 and 4, at 316, the computer system 100 passes each canvas sub-component to the electronic document processor 190 for conversion into a respective electronic document portion. Each respective electronic document portion is a portion of the PDF document formed by converting the entirety of the user interface component. At 318, the electronic document processor 190 converts the canvas sub-component into the electronic document portion. The computer system 100 continues to execute the loop 306 until each individual sub-component identified at step 304 has been converted into a respective electronic document portion at step 318. As the electronic document processor 190 generates the electronic document portions, it merges those portions into the electronic document. After merging all the electronic document portions into the electronic document, at 320, the electronic document processor 190 returns the single electronic document to the computer system 100. Then, the computer system 100 displays the single electronic document in the display device.

FIG. 4 is a flow chart of an example of a process 400 of printing electronic documents from large HTML, screens. In some implementations, the process 400 is executed by the computer system 100. At 402, the computer system 100 identifies a user interface component rendered by a computer application on a display device. At 404, the computer system 100 divides the user interface into multiple sub-components. At 406, the computer system 100 converts each sub-component into a respective canvas component resulting in multiple canvas components. At 408, the computer system 100 converts each canvas component into a respective PDF document portion. At 410, the computer system 100 merges all PDF document portions into a single PDF document. In some implementations, the computer system 100 generates and stores each PDF document portion and merges all the PDF document portions into the PDF document in one step. Alternatively or in addition, each time that the computer system 100 generates a PDF document portion, it merges that PDF document portion with a previously-generated PDF document portion. By doing so, the computer system 100 assembles all the PDF document portions, one portion at a time, into the final PDF document. At 412, the computer system 100 displays the PDF document on the display device.

In the implementations described earlier, the computer system 100 divided the user interface component into multiple sub-components and performed processing on each sub-component. In some implementations, the number of sub-components into which the user interface component is to be divided can be specified by a user. For example, if the user interface component is a table that includes several, for example, more than 100 rows, then the user can specify that each sub-component include 10 or fewer rows. In such implementations, the user interface component is divided horizontally. Alternatively or in addition, the computer system 100 can divide the user interface component vertically. For example, if the user interface component is a table that includes several, for example, more than 100 columns, then the user can specify that the user interface component be divided vertically and that each sub-component include 10 or fewer components. Another example in which the user interface component can be divided vertically is when the HTML screen to be printed as an electronic document is a map. The user can decide the number of sub-components into which the user interface component is divided based on the users experience with converting the user interface component into an electronic document and based on constraints, for example, timeout and canvas size thresholds, associated with the computer application that renders the user interface component.

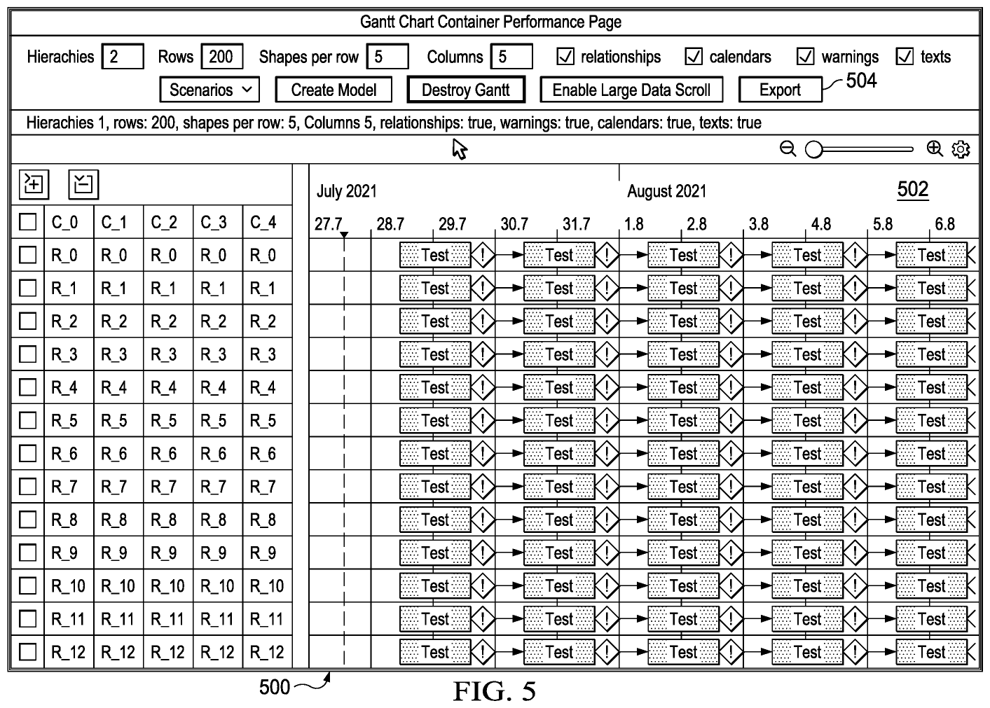

FIG. 5 is an example of a display device 500 displaying a user interface 502 generated using HTML5. The example user interface 502 is a Gantt chart having parameters specified at the top of the chart. The user interface 502 includes a selectable object 504, for example, a button object labeled “Export” or “Print”. The user input that initiates the conversion of the user interface 502 into an electronic document in accordance with the implementations described here is the selection of the selectable object 504.

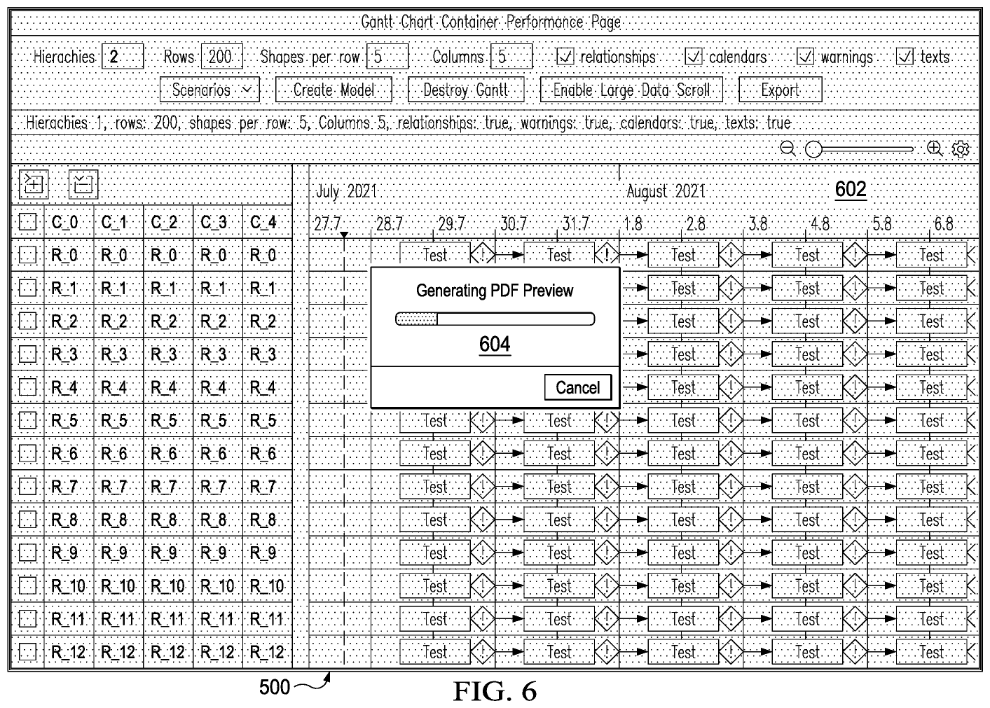

FIG. 6 is an example of the display device 500 displaying a user interface 602 showing progress of converting the user interface 502 into an electronic document. In response to receiving a selection of the selectable object 504, the computer system 100 initiates the conversion processes described here. In some implementations, the computer system 100 presents a user interface 602 overlaying or in place of the user interface 502. In the user interface 602, the computer system 100 displays a progress bar 604 that indicates a continuously updated status of the conversion.

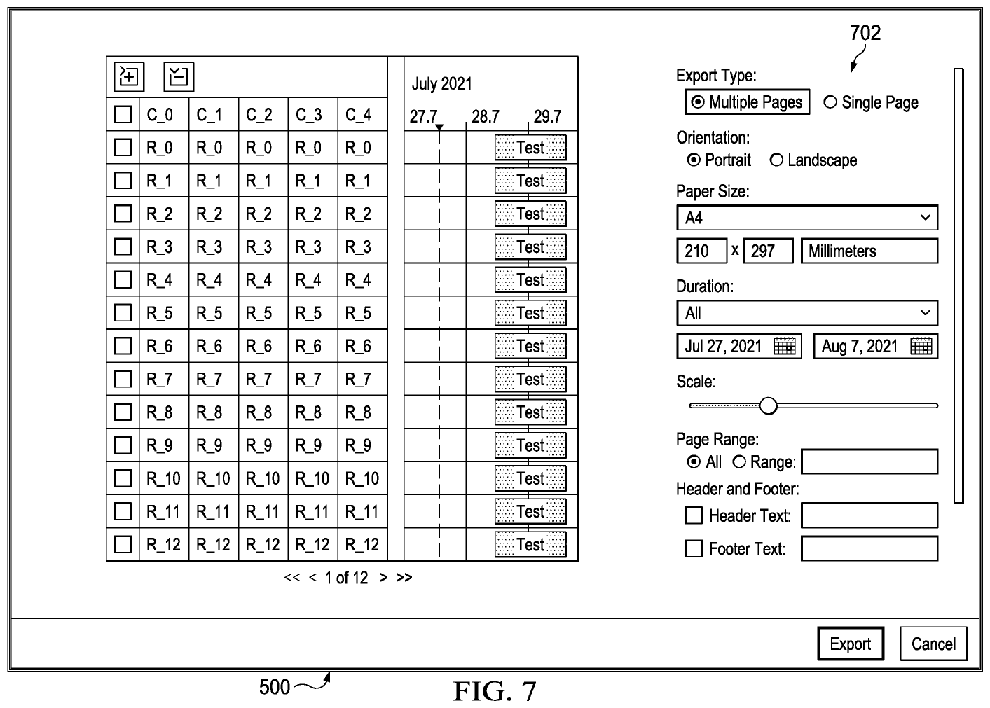

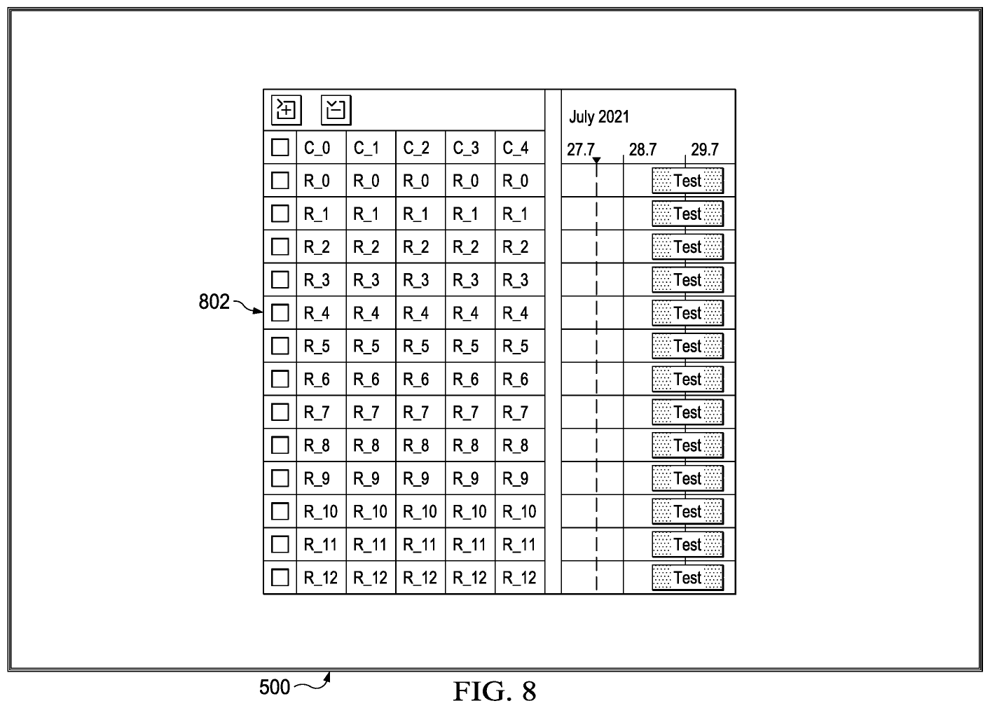

FIG. 7 is an example of the display device 500 displaying a preview of the electronic document 702. After successful conversion of the user interface 502 into an electronic document, the computer system 100 displays the user interface 702 which includes a preview of the electronic document. At this stage, a user can provide input to the computer system 100 accepting the electronic document. In response, the computer system 100 can display the electronic document in the display device 500. FIG. 8 is an example of the display device 500 displaying the electronic document 802.

This disclosure describes certain implementations in the context of printing PDF documents. However, the techniques described here can be implemented to print user interface components, for example, HTML screens, in formats other than PDF, for example, PNG, JPG and other electronic document formats subject to the capability of the Electronic Document Processor 190 to convert the canvas into such formats.

An electronic document (which for brevity will simply be referred to as a document) may, but need not, correspond to a file. A document may be stored in a portion of a file that holds other documents, in a single file dedicated to the document in question, or in multiple coordinated files.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “processor” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well, for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
identifying a user interface component rendered by a computer application on a display device;
dividing the user interface component into a plurality of sub-components;
converting each sub-component into a respective canvas component resulting in a plurality of canvas components, wherein a size of each sub-component is selected such that a time taken to convert each sub-component into the respective canvas component is less than a threshold timeout associated with the computer application that rendered the user interface component;
converting the plurality of canvas components into a portable document format (PDF) document; and
displaying the PDF document on the display device.

2. The method of claim 1, wherein converting the plurality of canvas components into the PDF document comprises:
merging the plurality of canvas components into a single merged canvas component; and
converting the single merged canvas component into the PDF document.

3. The method of claim 1, wherein converting the plurality of canvas components into the PDF document comprises:
converting each canvas sub-component into a respective PDF document portion resulting in a plurality of PDF documents, each being a portion of the PDF document; and
merging the plurality of PDF documents into the PDF document.

4. The method of claim 3, further comprising selecting a size of each canvas sub-component based on a threshold size of a canvas sub-component that the computer application that rendered the user interface can support.

5. The method of claim 1, further comprising receiving input comprising a number of the plurality of sub-components into which the user interface component is to be divided, wherein dividing the user interface component into the plurality of sub-components comprises dividing the user interface component into at least the number of the plurality of sub-components specified in the input.

6. The method of claim 1, wherein dividing the user interface component into the plurality of sub-components comprises dividing the user interface component into a plurality of horizontal or vertical sub-components.

7. The method of claim 1, further comprising receiving user input to convert the user interface component into the PDF document.

8. A system comprising:
one or more computers; and
a computer-readable medium coupled to the one or more computers having instructions stored thereon which, when executed by the one or more computers, cause the one or more computers to perform operations comprising:
identifying a user interface component rendered by a computer application on a display device;
dividing the user interface component into a plurality of sub-components;
converting each sub-component into a respective canvas component resulting in a plurality of canvas components, wherein a size of each sub-component is selected such that a time taken to convert each sub-component into the respective canvas component is less than a threshold timeout associated with the computer application that rendered the user interface component;
converting the plurality of canvas components into a portable document format (PDF) document; and
displaying the PDF document on the display device.

9. The system of claim 8, wherein converting the plurality of canvas components into the PDF document comprises:
merging the plurality of canvas components into a single merged canvas component; and
converting the single merged canvas component into the PDF document.

10. The system of claim 8, wherein converting the plurality of canvas components into the PDF document comprises:
converting each canvas sub-component into a respective PDF document portion resulting in a plurality of PDF documents, each being a portion of the PDF document; and
merging the plurality of PDF documents into the PDF document.

11. The system of claim 10, wherein the operations further comprise selecting a size of each canvas sub-component based on a threshold size of a canvas sub-component that the computer application that rendered the user interface can support.

12. The system of claim 8, wherein the operations further comprise receiving input comprising a number of the plurality of sub-components into which the user interface component is to be divided, wherein dividing the user interface component into the plurality of sub-components comprises dividing the user interface component into at least the number of the plurality of sub-components specified in the input.

13. The system of claim 8, wherein dividing the user interface component into the plurality of sub-components comprises dividing the user interface component into a plurality of horizontal or vertical sub-components.

14. The system of claim 8, wherein the operations further comprise receiving user input to convert the user interface component into the PDF document.

15. A non-transitory computer-readable medium coupled to one or more computers having instructions stored thereon which, when executed by the one or more computers, cause the one or more computers to perform operations comprising:
receiving, via a user interface displayed on a display device, input to convert a user interface component rendered by a computer application on the display device into a portable document format (PDF) document; and
in response to receiving the user input:
identifying the user interface component,
dividing the user interface component into a plurality of sub-components,
converting each sub-component into a respective canvas component resulting in a plurality of canvas components, wherein a size of each sub-component is selected such that a time taken to convert each sub-component into the respective canvas component is less than a threshold timeout associated with the computer application that rendered the user interface component,
converting the plurality of canvas components into a portable document format (PDF) document, and
displaying the PDF document on the display device.

16. The medium of claim 15, wherein converting the plurality of canvas components into the PDF document comprises:
merging the plurality of canvas components into a single merged canvas component; and
converting the single merged canvas component into the PDF document.

17. The medium of claim 15, wherein converting the plurality of canvas components into the PDF document comprises:
converting each canvas sub-component into a respective PDF document portion resulting in a plurality of PDF documents, each being a portion of the PDF document; and
merging the plurality of PDF documents into the PDF document.

18. The medium of claim 17, wherein the operations further comprise selecting a size of each canvas sub-component based on a threshold size of a canvas sub-component that the computer application that rendered the user interface can support.

19. The medium of claim 15, wherein the operations further comprise receiving input comprising a number of the plurality of sub-components into which the user interface component is to be divided, wherein dividing the user interface component into the plurality of sub-components comprises dividing the user interface component into at least the number of the plurality of sub-components specified in the input.

20. The medium of claim 15, wherein dividing the user interface component into the plurality of sub-components comprises dividing the user interface component into a plurality of horizontal or vertical sub-components.
